(19) United States
(12) Patent Application Publication
(10) Pub. No.: US 2016/0129640 A1
(43) Pub. Date: May 12, 2016

(54) THREE-DIMENSIONAL OBJECT FORMATION APPARATUS, CONTROL METHOD OF THREE-DIMENSIONAL OBJECT FORMATION APPARATUS, AND CONTROL PROGRAM OF THREE-DIMENSIONAL OBJECT FORMATION APPARATUS

(71) Applicant: SEIKO EPSON CORPORATION, Tokyo (JP)

(72) Inventor: Satoshi YAMAZAKI, Matsumoto (JP)

(21) Appl. No.: 14/851,112

(22) Filed: Sep. 11, 2015

(30) Foreign Application Priority Data
Nov. 12, 2014 (JP) 2014-230166

(51) Int. Cl. B29C 67/00; G05B 19/18

(52) U.S. Cl. CPC B29C 67/0088; G05B 19/182; B33Y 50/02

(57) ABSTRACT

Provided is a three-dimensional object formation apparatus including: a head unit which discharges a plurality of types of liquid including first liquid, second liquid, and third liquid, and forms dots with the discharged liquid; a curing unit which cures the dots; and a control unit which controls the head unit, in which the control unit controls the head unit so that the three-dimensional object which includes a first layer, a second layer, and a third layer and in which the first layer and the second layer are provided between the third layer and the outer surface of the three-dimensional object so as to separate the third layer and the outer surface of the three-dimensional object, and the second layer is provided between the first layer and the third layer so as to separate the first layer and the third layer, is formed.

This application claims priority to Japanese Patent Application No. 2014-230166 filed on Nov. 12, 2014. The entire disclosure of Japanese Patent Application No. 2014-230166 is hereby incorporated herein by reference.

### BACKGROUND

1. Technical Field

The present invention relates to a three-dimensional object formation apparatus, a control method of a three-dimensional object formation apparatus, and a control program of a three-dimensional object formation apparatus.

2. Related Art

In recent years, various three-dimensional object formation apparatuses such as a 3D printer have been proposed. The three-dimensional object formation apparatus cures dots which are formed by discharging liquid such as ink, forms a formation layer having a predetermined thickness with the cured dots, and laminates the formed formation bodies to form a three-dimensional object. In such a three-dimensional object formation apparatus, in order to form a colored three-dimensional object, various techniques of forming a surface portion including an outer surface of the three-dimensional object with chromatic liquid such as color ink have been proposed (for example, see JP-A-2013-075390).

However, since chromatic liquid such as color ink has a large number of color material components included in the liquid, the cost necessary for forming a three-dimensional object increases, compared to a case of forming a three-dimensional object with transparent liquid such as clear ink, for example. For example, in JP-A-2013-075390, the cost relating to the formation of the three-dimensional object is decreased by forming the inner portion of the three-dimensional object with the transparent liquid.

However, when forming the inner portion of the three-dimensional object with the transparent liquid, the color of the inner portion of the three-dimensional object may be visualized from the outside of the three-dimensional object through the surface portion, or the color of the surface portion may be visualized as a transparent color which is lighter than a color as originally intended. In such a case, the three-dimensional object is visualized as a color which is different from the color as originally intended.

### SUMMARY

An advantage of some aspects of the invention is to provide a technology of properly displaying a color to be displayed in a three-dimensional object, while decreasing the cost necessary for the formation of the three-dimensional object formed by a three-dimensional object formation apparatus.

According to an aspect of the invention, there is provided a three-dimensional object formation apparatus including: a head unit which discharges a plurality of types of liquid including a first liquid including chromatic color material components, a second liquid which reflects visible light at a rate equal to or greater than a predetermined rate, and a third liquid having a smaller number of color material components than those of the first liquid and the second liquid, and forms dots with the discharged liquid; a curing unit which cures the dots; and a control unit which controls the head unit so that a three-dimensional object is formed with the cured dots, in which the control unit controls the head unit so that the three-dimensional object which includes a first layer formed of a plurality of dots including the dots formed with the first liquid, a second layer formed of a plurality of dots formed with the second liquid, and a third layer formed of a plurality of dots formed with the third liquid and in which the first layer and the second layer are provided between the third layer and the outer surface of the three-dimensional object so as to separate the third layer and the outer surface of the three-dimensional object, and the second layer is provided between the first layer and the third layer so as to separate the first layer and the third layer, is formed.

That is, the three-dimensional object formation apparatus according to the aspect of the invention may include a head unit which discharges a plurality of types of liquid including a first liquid including chromatic color material components, a second liquid which reflects visible light at a rate equal to or greater than a predetermined rate, and a third liquid having a smaller number of color material components than those of the first liquid and the second liquid, and forms dots with the discharged liquid, and a curing unit which cures the dots, the three-dimensional object formation apparatus forms a three-dimensional object by overlapping formation bodies formed with the cured dots, the three-dimensional object includes a first layer formed of a plurality of dots including the dots formed with the first liquid, a second layer formed of a plurality of dots formed with the second liquid, and a third layer formed of a plurality of dots formed with the third liquid, the first layer and the second layer are provided between the third layer and the outer surface of the three-dimensional object so as to separate the third layer and the outer surface of the three-dimensional object, and the second layer is provided between the first layer and the third layer so as to separate the first layer and the third layer.

In this case, the second layer formed of the second liquid which reflects visible light at a rate equal to or greater than a predetermined rate is provided on the inner side of the first layer formed to include the first liquid including the chromatic color material components. Accordingly, most of light emitted to the three-dimensional object from the outside of the three-dimensional object is reflected by the first layer or the second layer. Therefore, it is possible to prevent the transmission of the light emitted to the three-dimensional object from the outside of the three-dimensional object, to the inner side with respect to the second layer. Therefore, it is possible to prevent the color of the inside of the three-dimensional object from being visualized from the outside of the three-dimensional object. Thus, it is possible to prevent the three-dimensional object from being visualized as a color different from the color as originally intended.

As the second liquid, a typical white ink can be used, and in addition, light color ink such as light cyan ink or light magenta ink can be used.

According to the aspect of the invention, the third layer formed of the third liquid having the smaller number of color material components than the first liquid and the second liquid is provided on the inner side with respect to the second layer. Accordingly, it is possible to decrease the cost for forming the three-dimensional object, by comparing a case where the three-dimensional object is formed of only the first layer and the second layer.

In the three-dimensional object formation apparatus described above, it is preferable that the second liquid includes achromatic color material components.

In this case, since the second layer has achromatic color, even when the light emitted to the three-dimensional object from the outside of the three-dimensional object is reflected by the second layer, it is possible to prevent the three-dimensional object from being visualized as a color different from the color as originally intended.

In the three-dimensional object formation apparatus described above, it is preferable that the third layer is thicker than the second layer.

In this case, since the third layer having the small number of color material components is thicker than the second layer, it is easy to ensure the strength of the formed three-dimensional object, compared to a case where the third layer is thinner than the second layer.

In the three-dimensional object formation apparatus described above, it is preferable that the third layer is thicker than the first layer.

In this case, since the third layer having the small number of color material components is thicker than the first layer, it is easy to ensure the strength of the formed three-dimensional object, compared to a case where the third layer is thinner than the first layer.

In the three-dimensional object formation apparatus described above, it is preferable that the second layer is thicker than the first layer.

In this case, since the second layer is thicker than the first layer, it is possible to more reliably prevent the color of the inside of the three-dimensional object from being visualized from the outside of the three-dimensional object, compared to a case where the second layer is thinner than the first layer.

In the three-dimensional object formation apparatus described above, it is preferable that the first layer is thicker than the second layer.

In this case, since the first layer is thicker than the second layer, it is possible to make the color displayed by the first layer darker, compared to a case where the first layer is thinner than the second layer.

According to another aspect of the invention, there is provided a control method of a three-dimensional object formation apparatus which includes a head unit which discharges a plurality of types of liquid including a first liquid including chromatic color material components, a second liquid which reflects visible light at a rate equal to or greater than a predetermined rate, and a third liquid having a smaller number of color material components than those of the first liquid and the second liquid, and forms dots with the discharged liquid, and a curing unit which cures the dots, the method including: controlling the head unit so that the three-dimensional object which includes a first layer formed of a plurality of dots including the dots formed with the first liquid, a second layer formed of a plurality of dots formed with the second liquid, and a third layer formed of a plurality of dots formed with the third liquid and in which the first layer and the second layer are provided between the third layer and the outer surface of the three-dimensional object so as to separate the third layer and the outer surface of the three-dimensional object, and the second layer is provided between the first layer and the third layer so as to separate the first layer and the third layer, is formed with the cured dots.

In this case, it is possible to prevent the three-dimensional object from being visualized as a color different from the color as originally intended and to decrease the cost for forming the three-dimensional object.

According to still another aspect of the invention, there is provided a control program of a three-dimensional object formation apparatus which includes a head unit which discharges a plurality of types of liquid including a first liquid including chromatic color material components, a second liquid which reflects visible light at a rate equal to or greater than a predetermined rate, and a third liquid having a smaller number of color material components than those of the first liquid and the second liquid, and forms dots with the discharged liquid, a curing unit which cures the dots, and a computer, the program causing the computer to function as: a control unit which controls the head unit so that the three-dimensional object which includes a first layer formed of a plurality of dots including the dots formed with the first liquid, a second layer formed of a plurality of dots formed with the second liquid, and a third layer formed of a plurality of dots including the dots formed with the third liquid and in which the first layer and the second layer are provided between the third layer and the outer surface of the three-dimensional object so as to separate the third layer and the outer surface of the three-dimensional object, and the second layer is provided between the first layer and the third layer so as to separate the first layer and the third layer, is formed with the cured dots.

In this case, it is possible to prevent the three-dimensional object from being visualized as a color different from the color as originally intended and to decrease the cost for forming the three-dimensional object.

### BRIEF DESCRIPTION OF THE DRAWINGS

The invention will be described with reference to the accompanying drawings, wherein like numbers reference like elements.

FIG. 1 is a block diagram showing a configuration of a three-dimensional object formation system according to the invention.

FIGS. 2A to 2E are explanatory diagrams for illustrating the formation of an object by the three-dimensional object formation system.

FIG. 3 is a schematic sectional view of a three-dimensional object formation apparatus.

FIG. 4 is a schematic sectional view of a recording head.

FIGS. 5A to 5C are explanatory diagrams for illustrating an operation of a discharging unit when supplying a driving signal.

FIG. 6 is a plan view showing an arrangement example of nozzles of the recording head.

FIG. 7 is a block diagram showing a configuration of a driving signal generation unit.

FIG. 8 is an explanatory diagram showing content of a selection signal.

FIG. 9 is a timing chart showing waveforms of a driving waveform signal.

FIG. 10 is a flowchart showing a data generation process and a formation process.

FIGS. 11A and 11B are perspective views for illustrating a three-dimensional object.

FIGS. 12A and 12B are sectional views for illustrating an inner structure of the three-dimensional object.

FIG. 13 is a flowchart for illustrating a shape complementation process.

FIG. 14 is a flowchart showing a data generation process and a formation process according to Modification Example 3.

FIGS. 15A to 15F are explanatory diagrams for illustrating the formation of a three-dimensional object by the three-dimensional object formation system according to Modification Example 3.

### DESCRIPTION OF EXEMPLARY EMBODIMENTS

Hereinafter, embodiments for realizing the invention will be described with reference to the drawings. Herein, in each drawing, dimensions and scales of each drawing are appropriately modified from the actual dimensions and scales. The embodiments which will be described below are preferable specific examples of the invention, and therefore, various technologically preferable limitations are set. However, the scope of the invention is not limited to the embodiments, unless there is a limitation of the invention in the following description.

### A. Embodiment

In the embodiment, as a three-dimensional object formation apparatus, an ink jet type three-dimensional object formation apparatus which discharges a curable ink (an example of “liquid”) such as resin ink containing a resin emulsion or ultraviolet curable ink to form a three-dimensional object Obj will be described as an example.

### 1. Configuration of Three-Dimensional Object Formation System

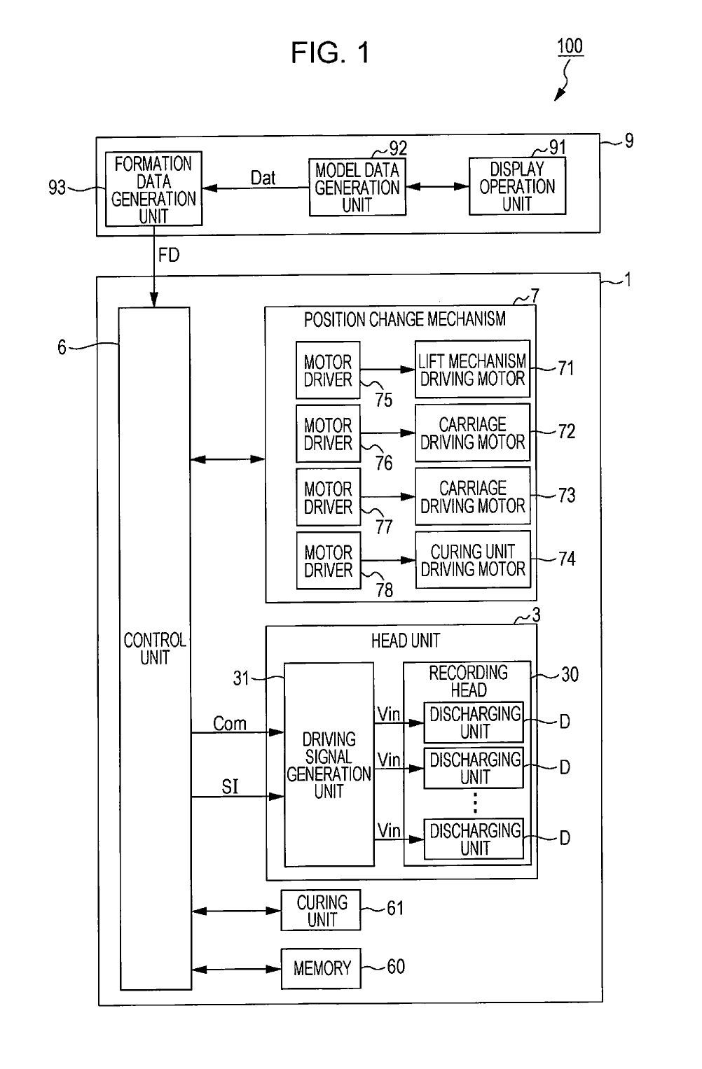

Hereinafter, a configuration of a three-dimensional object formation system 100 including a three-dimensional object formation apparatus 1 according to the embodiment will be described with reference to FIG. 1 to FIG. 9.

FIG. 1 is a functional block diagram showing a configuration of the three-dimensional object formation system 100.

As shown in FIG. 1, the three-dimensional object formation system 100 includes the three-dimensional object formation apparatus 1 which executes a formation process of discharging ink, forming a layered formation body LY having a predetermined thickness ΔZ with dots formed by the discharged ink, and laminating the formation bodies LY to form a three-dimensional object Obj, and a host computer 9 which executes a data generation process of generating formation body data FD which determines a shape and a color of each of the plural formation bodies LY configuring the three-dimensional object Obj which is formed by the three-dimensional object formation apparatus 1.

### 1.1. Host Computer

As shown in FIG. 1, the host computer 9 includes a CPU (not shown) which controls an operation of each unit of the host computer 9, a display unit (not shown) such as a display, an operation unit 91 such as a keyboard or a mouse, an information memory (not shown) on which a control program of the host computer 9, a driver program of the three-dimensional object formation apparatus 1, and an application program such as computer aided design (CAD) software are recorded, a model data generation unit 92 which generates model data Dat, and a formation data generation unit 93 which executes a data generation process of generating the formation body data FD based on the model data Dat.

Herein, the model data Dat is data showing the shape and the color of the model representing a three-dimensional object Obj which is to be formed by the three-dimensional object formation apparatus 1 and is data for designating the shape and the color of the three-dimensional object Obj.

The model data generation unit 92 is a functional block which is realized by execution of the application program recorded on the information memory by the CPU of the host computer 9. The model data generation unit 92 is, for example, a CAD application, and generates the model data Dat which designates the shape and the color of the three-dimensional object Obj based on information which is input by operating the operation unit 91 by a user of the three-dimensional object formation system 100.

In the embodiment, a case where the model data Dat designates an external shape of the three-dimensional object Obj is assumed. That is, a case where the model data Dat is data which designates a shape of a hollow object in a case where it is assumed that the three-dimensional object Obj is the hollow object, that is, a shape of an outline of the three-dimensional object Obj, is assumed. For example, when the three-dimensional object Obj is a sphere, the model data Dat shows a spherical shape which is an outline of the sphere.

However, the invention is not limited to such an embodiment, and the model data Dat may include at least information in which the shape of the outer shape of the three-dimensional object Obj can be specified. For example, the model data Dat may designate a shape or a material of the inside of the three-dimensional object Obj, in addition to the outer shape or the color of the three-dimensional object Obj.

As the model data Dat, a data format such as Additive Manufacturing File Format (AMF) or Standard Triangulated Language (STL) can be used, for example.

The formation data generation unit 93 is a functional block which is realized by execution of the driver program of the three-dimensional object formation apparatus 1 recorded on the information memory by the CPU of the host computer 9. The formation data generation unit 93 executes a data generation process of generating the formation body data FD which determines a shape and a color of the formation body LY formed by the three-dimensional object formation apparatus 1, based on the model data Dat generated by the model data generation unit 92.

Hereinafter, a case where the three-dimensional object Obj is formed by laminating Q layered formation bodies LY is assumed (Q is a natural number satisfying an expression of Q≧2). Hereinafter, the process of forming the formation bodies LY by the three-dimensional object formation apparatus 1 is referred to as a lamination process. That is, the formation process of forming the three-dimensional object Obj by the three-dimensional object formation apparatus 1 includes Q times of the lamination processes.

Hereinafter, a formation body LY which is formed in the q-th lamination process among the Q times of the lamination processes included in the formation process is referred to as a formation body LY[q] and the formation body data FD which determines the shape and the color of the formation body LY[q] is referred to as the formation body data FD[q] (q is a natural number satisfying an expression of 1≦q≦Q).

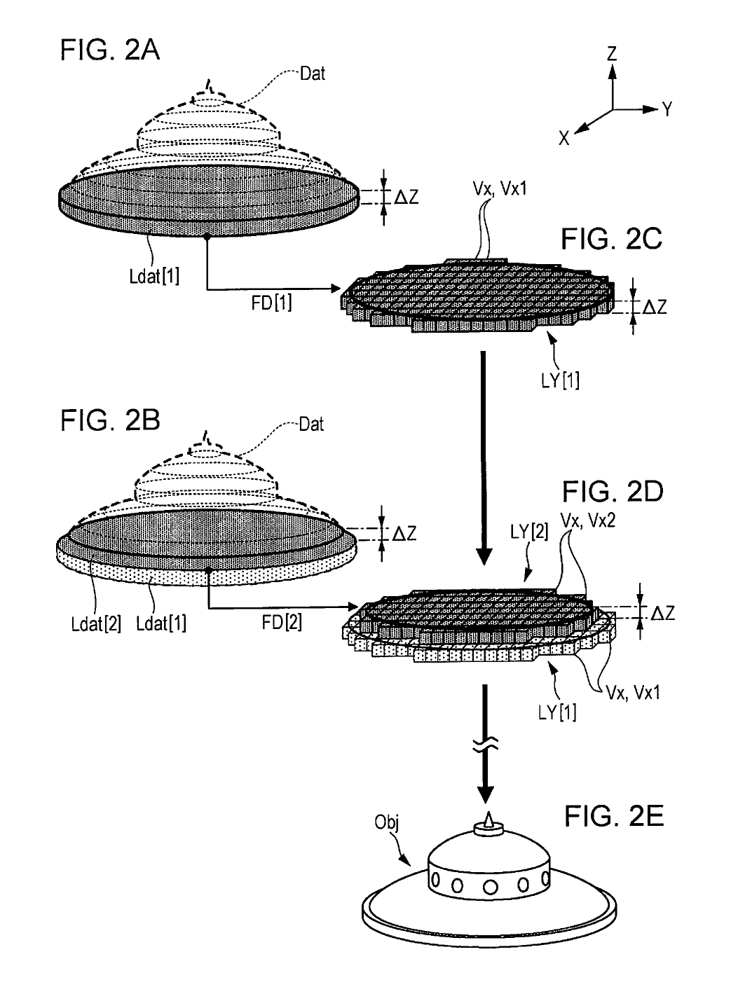

FIGS. 2A to 2E are explanatory diagrams for illustrating a relationship between the model data Dat and the formation body LY formed based on the formation body data FD.

As shown in FIGS. 2A and 2B, in order to generate formation body data items FD[1] to FD[Q] which determine the shape and the color of formation bodies LY[1] to LY[Q] having a predetermined thickness ΔZ, the formation data generation unit 93 first slices a three-dimensional shape shown by the model data Dat into the predetermined thickness ΔZ to generate section model data items Ldat[1] to Ldat[Q] respectively corresponding to the formation bodies LY[1] to LY[Q]. Herein, the section model data Ldat is data showing the shape and the color of the section body which is obtained by slicing the shape of the three-dimensional shape shown by the model data Dat. However, the section model data Ldat may be data including the shape and the color of the section when the three-dimensional shape shown by the model data Dat is sliced.

FIG. 2A shows the section model data Ldat[1] corresponding to the formation body LY[1] which is formed in the first lamination process and FIG. 2B shows the section model data Ldat[2] corresponding to the formation body LY[2] which is formed in the second lamination process.

Next, in order to form the formation body LY[q] corresponding to the shape and the color shown by the section model data Ldat[q], the formation data generation unit 93 determines the arrangement of dots to be formed by the three-dimensional object formation apparatus 1 and outputs the determined results as the formation body data FD[q]. That is, the formation body data FD[q] is data which designates dots to be formed in each of plural voxels Vx, when the shape and the color shown by the section model data Ldat[q] are segmented in a lattice shape and the shape and the color shown by the section model data Ldat[q] are represented as an assembly of voxels Vx. Herein, the voxel Vx is a cuboid or a cube having a predetermined size and is a cuboid or a cube having the predetermined thickness ΔZ and a predetermined volume. In the embodiment, the volume and the size of the voxel Vx are determined according to the size of the dots which can be formed by the three-dimensional object formation apparatus 1. Hereinafter, the voxel Vx corresponding to the formation body LY[q] may be referred to as a voxel Vxq.

Hereinafter, a constituent element of the formation body LY configuring the three-dimensional object Obj which is formed corresponding to one voxel Vx and has the predetermined volume and the predetermined thickness ΔZ may be referred to as a unit structure. The details will be described later, and the unit structure is configured with one or the plurality of dots. That is, the unit structure is one or the plurality of dots which are formed so as to satisfy one voxel Vx. That is, in the embodiment, the formation body data FD designates that one or the plurality of dots are formed in each voxel Vx.

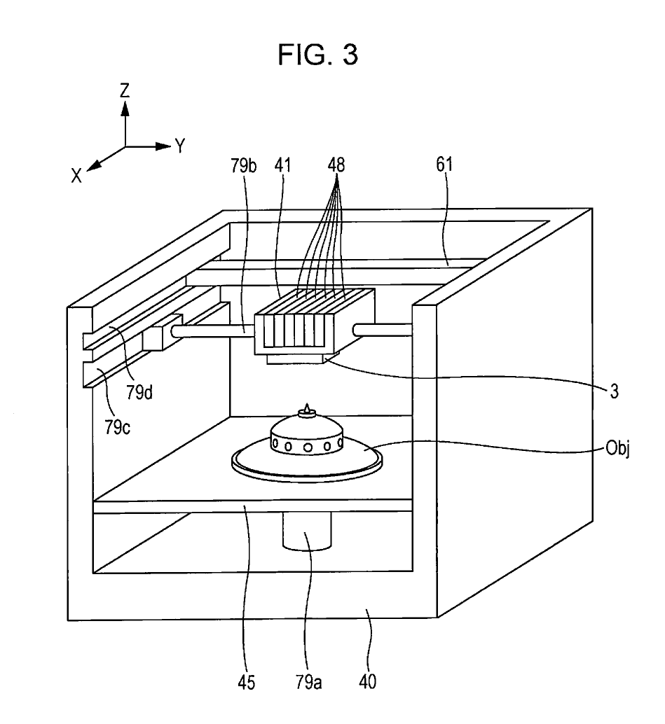

As shown in FIGS. 2C and 2D, the three-dimensional object formation apparatus 1 executes the lamination process of forming the formation body LY[q] based on the formation body data FD[q] generated by the formation data generation unit 93. FIG. 2C shows the first formation body LY[1] formed on a formation table 45 (refer to FIG. 3) based on the formation body data FD[1] generated from the section model data Ldat[1] and FIG. 2D shows the second formation body LY[2] formed on the formation body LY[1] based on the formation body data FD[2] generated from the section model data Ldat[2].

As shown in FIG. 2E, the three-dimensional object formation apparatus 1 forms the three-dimensional object Obj by sequentially laminating the formation bodies LY[1] to LY[Q] formed based on the formation body data items FD[1] to FD[Q].

As described above, the model data Dat according to the embodiment designates the shape of the outer shape (shape of the outline) of the three-dimensional object Obj. Accordingly, when the three-dimensional object Obj having the shape shown by the model data Dat is reliably formed, the shape of the three-dimensional object Obj becomes a hollow shape. However, when forming the three-dimensional object Obj, it is preferable to determine the shape of the inside of the three-dimensional object Obj, by considering the strength of the three-dimensional object Obj. Specifically, when forming the three-dimensional object Obj, it is preferable that a part or the entirety of the inside of the three-dimensional object Obj has a solid structure.

Accordingly, as shown in FIGS. 2A to 2E, the formation data generation unit 93 according to the embodiment generates the formation body data FD so that a part or the entirety of the inside of the three-dimensional object Obj has a solid structure, regardless of the fact that the shape designated by the model data Dat is a hollow shape.

Hereinafter, a process of complementing the hollow portion having a shape shown by the model data Dat and generating the section model data Ldat showing the shape in which a part of or the entire hollow portion has a solid structure is referred to as a shape complementation process. The shape complementation process and the structure of the inside of the three-dimensional object Obj designated by the data generated by the shape complementation process will be described later in detail.

In the example shown in FIGS. 2A to 2E, a voxel Vx1 configuring the formation body LY[1] formed in the first lamination process exists on the lower side (negative Z direction) of a voxel Vx2 configuring the formation body LY[2] formed in the second lamination process. However, the voxel Vx1 may not exist on the lower side of the voxel Vx2 depending on the shape of the three-dimensional object Obj. In such a case, although a dot is attempted to be formed in the voxel Vx2, the dot may fall down. Accordingly, when an expression of “q≧2” is satisfied, it is necessary to provide a support for supporting the dots formed in the voxel Vxq on the lower side of the voxel Vxq, in order to form the dots configuring the formation body LY[q] in the voxel Vxq as originally intended.

Therefore, in the embodiment, the formation body data FD includes the data which determines the shape of the support which is necessary when forming the three-dimensional object Obj, in addition to the three-dimensional object Obj. That is, in the embodiment, both of a portion of the three-dimensional object Obj to be formed in the q-th lamination process and a portion of the support to be formed in the q-th lamination process are included in the formation body LY[q]. That is, the formation body data FD[q] includes data representing the shape and the color of the part of the three-dimensional object Obj formed as the formation body LY[q] as an assembly of the voxel Vxq, and data representing the shape of the portion of the support formed as the formation body LY[q] an assembly of the voxel Vxq.

The formation data generation unit 93 according to the embodiment determines whether or not it is necessary to provide the support for forming the voxel Vxq, based on the section model data Ldat and the model data Dat. When the result of the determination is positive, the formation data generation unit 93 generates the formation body data FD for providing the support in addition to the three-dimensional object Obj.

The support is preferably configured with a material which is easily removed after the formation of the three-dimensional object Obj, for example, water-soluble ink.

### 1.2. Three-Dimensional Object Formation Apparatus

Next, the three-dimensional object formation apparatus 1 will be described with reference to FIG. 3, in addition to FIG. 1. FIG. 3 is a perspective view schematically showing the inner structure of the three-dimensional object formation apparatus 1.

As shown in FIG. 1 and FIG. 3, the three-dimensional object formation apparatus 1 includes a housing 40, the formation table 45, a control unit 6 which controls the operation of each unit of the three-dimensional object formation apparatus 1, a head unit 3 in which a recording head 30 including a discharging unit D discharging ink towards the formation table 45 is provided, a curing unit 61 which cures ink discharged onto the formation table 45, six ink cartridges 48, a carriage 41 on which the head unit 3 and the ink cartridges 48 are mounted, a position change mechanism 7 for changing the positions of the head unit 3, the formation table 45, and the curing unit 61 with respect to the housing 40, and a memory 60 on which a control program of the three-dimensional object formation apparatus 1 or other various information items are recorded.

The curing unit 61 is a constituent element for curing ink which is discharged onto the formation table 45, and a light source for emitting an ultraviolet ray to ultraviolet curable ink or a heater for heating resin ink can be exemplified, for example. When the curing unit 61 is a light source of an ultraviolet ray, the curing unit 61 is, for example, provided on the upper side (positive Z direction) of the formation table 45. Meanwhile, when the curing unit 61 is a superheater, the curing unit 61 may be, for example, embedded in the formation table 45 or provided on the lower side of the formation table 45.

Hereinafter, the description will be made by assuming that the curing unit 61 is a light source of an ultraviolet ray and the curing unit 61 is positioned in the positive Z direction of the formation table 45.

The six ink cartridges 48 are provided to correspond to a total of six types of ink including five colored formation inks for forming the three-dimensional object Obj and a supporting ink for forming the support, one by one. The type of ink corresponding to the ink cartridge 48 is filled in each ink cartridge 48.

The five colored formation ink for forming the three-dimensional object Obj include the chromatic ink including a chromatic color material component, the achromatic ink including an achromatic color material component, and clear (CL) ink having the content of the color material component per unit weight or unit volume which is smaller compared to the chromatic ink and the achromatic ink.

In the embodiment, as the chromatic ink, three colored ink of cyan (CY), magenta (MG), and yellow (YL) are used.

In the embodiment, white (WT) ink is used as the achromatic ink. When the light having a wavelength belonging to the wavelength area (approximately 400 nm to 700 nm) of a visible light is emitted to the white ink, the white ink according to the embodiment is ink which reflects a predetermined percentages or more light among the emitted light. The expression that “the predetermined percentage or more of light is reflected” has the same meaning as the expression that “less than the predetermined percentage or more of light is absorbed or transmitted”, and for example, corresponds to a case where the rate of the intensity of light reflected by the white ink with respect to the intensity of light emitted to the white ink is equal to or greater than the predetermined percentage. In the embodiment, the “predetermined percentage” may be, for example, an arbitrary percentage from 30% to 100%, preferably an arbitrary percentage equal to or greater than 50%, and more preferably an arbitrary percentage equal to or greater than 80%.

In the embodiment, the clear ink is ink having small content of a color material component and high transparency, compared to the chromatic ink and the achromatic ink.

Each ink cartridge 48 may be provided in separate places of the three-dimensional object formation apparatus 1, instead of being mounted on the carriage 41.

As shown in FIG. 1 and FIG. 3, the position change mechanism 7 includes a lift mechanism driving motor 71 for driving a formation table lift mechanism 79a which lifts the formation table 45 up and down in the positive Z direction and the negative Z direction (hereinafter, the positive Z direction and the negative Z direction may be collectively referred to as the “Z axis direction”), a carriage driving motor 72 for moving the carriage 41 along a guide 79b in a positive Y direction and a negative Y direction (hereinafter, the positive Y direction and the negative Y direction may be collectively referred to as the “Y axis direction”), a carriage driving motor 73 for moving the carriage 41 along a guide 79c in a positive X direction and a negative X direction (hereinafter, the positive X direction and the negative X direction may be collectively referred to as the “X axis direction”), and a curing unit driving motor 74 for moving the curing unit 61 along a guide 79d in the positive X direction and the negative X direction.

In addition, the position change mechanism 7 includes a motor driver 75 for driving the lift mechanism driving motor 71, a motor driver 76 for driving the carriage driving motor 72, a motor driver 77 for driving the carriage driving motor 73, and a motor driver 78 for driving the curing unit driving motor 74.

The memory 60 includes an electrically erasable programmable read-only memory (EEPROM) which is one kind of a nonvolatile semiconductor memory which stores the formation body data FD supplied from the host computer 9, a random access memory (RAM) which temporarily stores data which is necessary for executing various processes such as a formation process of forming the three-dimensional object Obj or temporarily develops a control program for controlling each unit of the three-dimensional object formation apparatus 1 so as to execute various processes such as the formation process, and a PROM which is one kind of a nonvolatile semiconductor memory which stores the control program.

The control unit 6 is configured to include a central processing unit (CPU) or a field-programmable gate array (FPGA) and controls the operation of each unit of the three-dimensional object formation apparatus 1 with the operation of the CPU which is performed along with the control program recorded on the memory 60.

The control unit 6 controls the operation of the head unit 3 and the position change mechanism 7 based on the formation body data FD supplied from the host computer 9 and accordingly, controls the execution of the formation process of forming the three-dimensional object Obj corresponding to the model data Dat on the formation table 45.

Specifically, first, the control unit 6 stores the formation body data FD supplied from the host computer 9 in the memory 60. Next, the control unit 6 generates various signals including a driving waveform signal Com and a waveform designation signal SI for driving the discharging unit D by controlling the operation of the head unit 3, based on various data recorded on the memory 60 such as the formation body data FD, and outputs the generated signals. In addition, the control unit 6 generates various signals for controlling the operations of the motor drivers 75 to 78 based on various data recorded on the memory 60 such as the formation body data FD, and outputs the generated signals.

The driving waveform signal Com is an analog signal. Accordingly, the control unit 6 includes a DA conversion signal (not shown) and converts a digital driving waveform signal generated in the CPU included in the control unit 6 into the analog driving waveform signal Com and then outputs the driving waveform signal.

As described above, the control unit 6 controls a relative position of the head unit 3 to the formation table 45 through the control of the motor drivers 75, 76, and 77 and controls a relative position of the curing unit 61 to the formation table 45 through the control of the motor drivers 75 and 78. In addition, the control unit 6 controls discharge of the ink from the discharging unit D, an amount of the ink discharged, and discharge timing of the ink through the control of the head unit 3.

Accordingly, the control unit 6 controls the execution of the lamination process of curing dots formed on the formation table 45 and forming the formation body LY, by adjusting the dot size and the dot arrangement regarding the dots which are formed by the ink discharged onto the formation table 45, and further controls the execution of the formation process of laminating the new formation body LY on the formation body LY already formed by repeatedly executing the lamination process and accordingly forming the three-dimensional object Obj corresponding to the model data Dat.

As shown in FIG. 1, the head unit 3 includes the recording head 30 including M discharging units D and a driving signal generation unit 31 which generates driving signals Vin for driving the discharging units D (M is a natural number equal to or greater than 1).

Hereinafter, in order to differentiate each of the M discharging units D provided in the recording head 30, the discharging units may be referred to as first, second, . . . , M-th discharging unit, sequentially. In addition, hereinafter, an m-th discharging unit D among the M discharging units D provided in the recording head 30 may be expressed as a discharging unit D[m] (m is a natural number which satisfies an expression of 1≦m≦M). In addition, hereinafter, a driving signal Vin for driving the discharging unit D[m] among the driving signals generated by the driving signal generation unit 31 may be expressed as a driving signal Vin[m].

The driving signal generation unit 31 will be described later in detail.

### 1.3. Recording Head

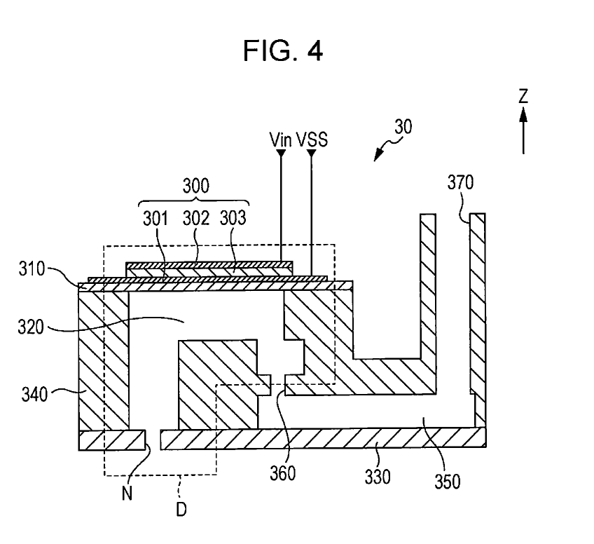

Next, the recording head 30 and the discharging units D provided in the recording head 30 will be described with reference to FIG. 4 to FIG. 6.

FIG. 4 is an example of a schematic partial sectional view of the recording head 30. In this drawing, for convenience of illustration, in the recording head 30, one discharging unit D among the M discharging units D included in the recording head 30, a reservoir 350 which is linked to the one discharging unit D through an ink supply port 360, and an ink inlet 370 for supplying the ink to the reservoir 350 from the ink cartridge 48 are shown.

As shown in FIG. 4, the discharging unit D includes a piezoelectric element 300, a cavity 320, inside of which is filled with the ink, a nozzle N which is linked to the cavity 320, and a vibration plate 310. The piezoelectric element 300 is driven by the driving signal Vin and accordingly the discharging unit D discharges the ink in the cavity 320 from the nozzle N. The cavity 320 is a space which is partitioned by a cavity plate 340 which is formed in a predetermined shape so as to have a recess, a nozzle plate 330 on which the nozzle N is formed, and the vibration plate 310. The cavity 320 is linked to the reservoir 350 through the ink supply port 360. The reservoir 350 is linked to one ink cartridge 48 through the ink inlet 370.

In the embodiment, a unimorph (monomorph) type as shown in FIG. 4 is used, for example, as the piezoelectric element 300. The piezoelectric element 300 is not limited to the unimorph type, and any type may be used such as a bimorph type or a lamination type, as long as the piezoelectric element 300 can be deformed to discharge the liquid such as ink.

The piezoelectric element 300 includes a lower electrode 301, an upper electrode 302, and a piezoelectric body 303 which is provided between the lower electrode 301 and the upper electrode 302. When a potential of the lower electrode 301 is set as a reference potential VSS, the driving signal Vin is supplied to the upper electrode 302, and accordingly, a voltage is applied between the lower electrode 301 and the upper electrode 302, the piezoelectric element 300 is bent (displaced) in a vertical direction of the drawing according to the applied voltage and as a result, the piezoelectric element 300 is vibrated.

The vibration plate 310 is installed on the upper opening of the cavity plate 340 and the lower electrode 301 is bonded to the vibration plate 310. Accordingly, when the piezoelectric element 300 is vibrated by the driving signal Vin, the vibration plate 310 is also vibrated. The volume of the cavity 320 (pressure in the cavity 320) changes according to the vibration of the vibration plate 310 and the ink filled in the cavity 320 is discharged by the nozzle N. When the ink in the cavity 320 is decreased due to the discharge of the ink, the ink is supplied from the reservoir 350. In addition, the ink is supplied to the reservoir 350 from the ink cartridge 48 through the ink inlet 370.

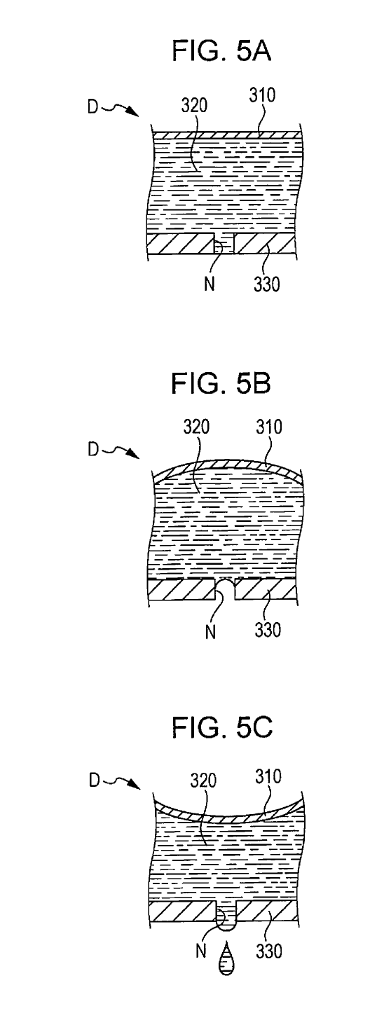

FIGS. 5A to 5C are explanatory diagrams illustrating a discharging operation of the ink from the discharging unit D. In a state shown in FIG. 5A, when the driving signal Vin is supplied to the piezoelectric element 300 included in the discharging unit D from the driving signal generation unit 31, distortion according to an electric field applied between the electrodes occurs in the piezoelectric element 300 and the vibration plate 310 of the discharging unit D is bent in the vertical direction of the drawing. Accordingly, as shown in FIG. 5B, the volume of the cavity 320 of the discharging unit D is expanded, compared to the initial state shown in FIG. 5A. In the state shown in FIG. 5B, when the potential shown by the driving signal Vin is changed, the vibration plate 310 is restored by an elastic restoring force and is moved downwards of the drawing by passing the position of the vibration plate 310 in the initial state, and the volume of the cavity 320 is rapidly contracted as shown in FIG. 5C. At that time, some ink filled in the cavity 320 is discharged as ink droplets from the nozzle N which is linked to the cavity 320, due to compression pressure generated in the cavity 320.

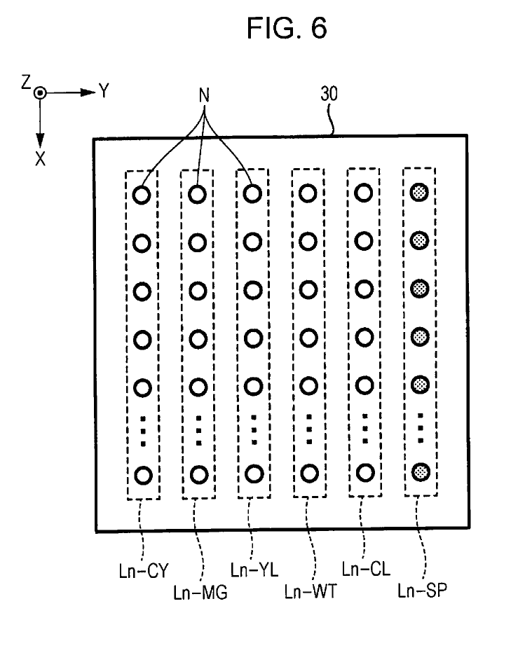

FIG. 6 is an explanatory diagram for illustrating an example of arrangement of M nozzles N provided in the recording head 30 in a plan view of the three-dimensional object formation apparatus 1 in a positive Z direction or a negative Z direction.

As shown in FIG. 6, in the recording head 30, six nozzle arrays Ln formed of a nozzle array Ln-CY formed of a plurality of nozzles N, a nozzle array Ln-MG formed of a plurality of nozzles N, a nozzle array Ln-YL formed of a plurality of nozzles N, a nozzle array Ln-WT formed of a plurality of nozzles N, a nozzle array Ln-CL formed of a plurality of nozzles N, and a nozzle array Ln-SP formed of a plurality of nozzles N, are provided. Herein, the nozzle N belonging to the nozzle array Ln-CY is a nozzle N provided in the discharging unit D for discharging the cyan (CY) ink, the nozzle N belonging to the nozzle array Ln-MG is a nozzle N provided in the discharging unit D for discharging the magenta (MG) ink, the nozzle N belonging to the nozzle array Ln-YL is a nozzle N provided in the discharging unit D for discharging the yellow (YL) ink, the nozzle N belonging to the nozzle array Ln-WT is a nozzle N provided in the discharging unit D for discharging the white (WT) ink, the nozzle N belonging to the nozzle array Ln-CL is a nozzle N provided in the discharging unit D for discharging the clear (CL) ink, and the nozzle N belonging to the nozzle array Ln-SP is a nozzle N provided in the discharging unit D for discharging the supporting ink.

In the embodiment, as shown in FIG. 6, a case where the plurality of nozzles N configuring each nozzle array Ln are arranged to be lined up in a line in the X axis direction has been used, but for example, the nozzles may be arranged in a so-called zigzag manner in which the positions of some nozzles N (for example, the even-numbered nozzles N) of the plurality of nozzles N configuring each nozzle array Ln and the positions of the other nozzles N (for example, odd-numbered nozzles N) are different from each other in the Y axis direction.

In addition, in each nozzle array Ln, a gap (pitch) between the nozzles N can be appropriately set according to the printing resolution (dpi: dot per inch).

### 1.4. Driving Signal Generation Unit

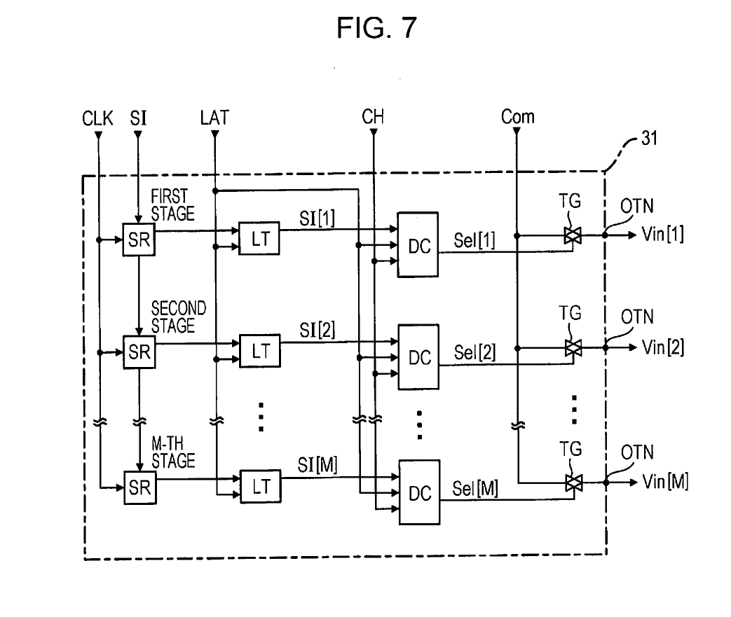

Next, the configuration and the operation of the driving signal generation unit 31 will be described with reference to FIG. 7 to FIG. 9.

FIG. 7 is a block diagram showing the configuration of the driving signal generation unit 31.

As shown in FIG. 7, the driving signal generation unit 31 includes M sets consisting of a shift resistor SR, a latch circuit LT, a decoder DC, and a transmission gate TG so as to respectively correspond to the M discharging units D provided in the recording head 30. Hereinafter, each element configuring the M sets included in the driving signal generation unit 31 and the recording head 30 is referred to as a first, second, . . . , and M-th element in the order from the top of the drawing.

A clock signal CLK, the waveform designation signal SI, a latch signal LAT, a change signal CH, and the driving waveform signal Com are supplied to the driving signal generation unit 31 from the control unit 6.

The waveform designation signal SI is a digital signal which designates an ink amount to be discharged by the discharging unit D and includes the waveform designation signals SI[1] to SI[M].

Among these, a waveform designation signal SI[m] regulates discharge or non-discharge of the ink from the discharging unit D[m] and the amount of the ink discharged with two bits of a high-order bit b1 and a low-order bit b2. Specifically, the waveform designation signal SI[m] regulates any one of discharging of ink of an amount corresponding to a large dot, discharging of ink of an amount corresponding to a medium dot, discharging of ink of an amount corresponding to a small dot, and non-discharging of ink, regarding the discharging unit D[m].

Each shift resistor SR temporarily holds the waveform designation signal SI[m] of two bits corresponding to each stage among the waveform designation signals SI (SI[1] to SI[M]). Specifically, the first, second, . . . , and M-th M shift resistors SR respectively corresponding to the M discharging units D[1] to D[M] are cascade-connected to each other, and the waveform designation signals SI supplied in serial order are transmitted in the order according to the clock signal CLK. When the waveform designation signals SI are transmitted to all of the M shift resistors SR, each of the M shift resistors SR holds the corresponding waveform designation signal SI[m] of 2 bits among the waveform designation signals SI.

Each of the M latch circuits LT simultaneously latches the waveform designation SI[m] of 2 bits corresponding to each stage held by each of the M shift resistors SR, at a timing when the latch signal LAT rises.

However, an operation period which is a period for executing the formation process by the three-dimensional object formation apparatus 1 is configured from a plurality of unit periods Tu. In the embodiment, each unit period Tu is formed of three control periods Ts (Ts1 to Ts3). In the embodiment, the three control periods Ts1 to Ts3 have a duration equivalent to each other. Although will be described later in detail, the unit period Tu is regulated by the latch signal LAT, and the control period Ts is regulated by the latch signal LAT and the change signal CH.

The control unit 6 supplies the waveform designation signal SI to the driving signal generation unit 31 at a timing before the unit period Tu is started. The control unit 6 supplies the latch signal LAT to each latch circuit LT of the driving signal generation unit 31 so that the waveform designation signal SI[m] is latched in each unit period Tu.

The m-th decoder DC decodes the waveform designation signal SI[m] of 2 bits which is latched by the m-th latch circuit LT and outputs a selection signal Sel[m] which is set as any level of a high level (H level) and a low level (L level) in each of the control periods Ts1 to Ts3.

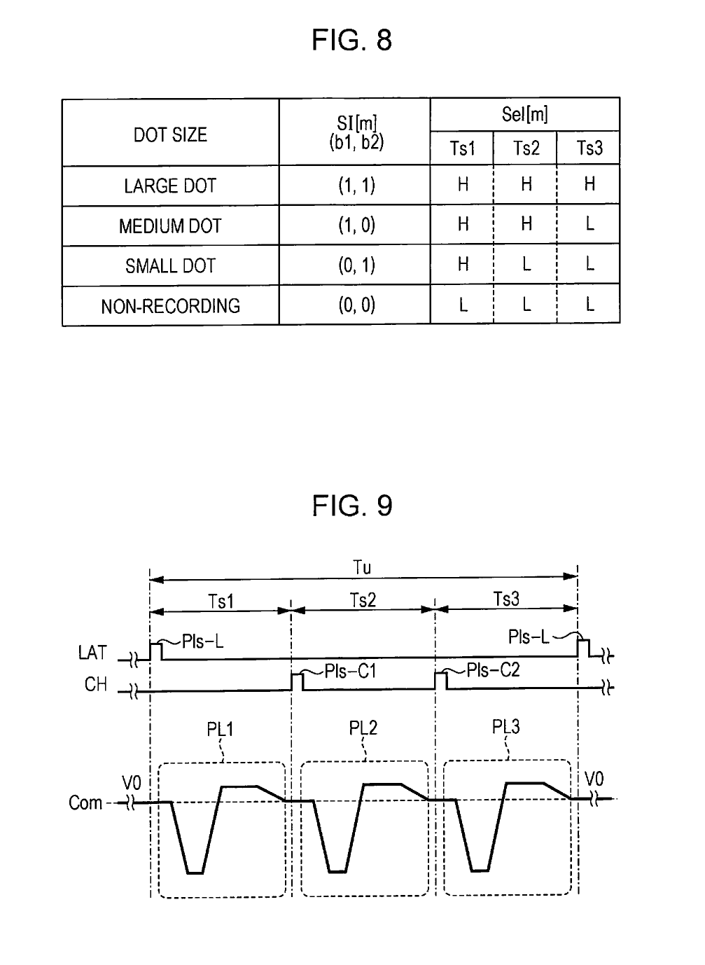

FIG. 8 is an explanatory diagram for illustrating the content of the decoding performed by the decoder DC.

As shown in the drawing, when the content shown by the waveform designation signal SI[m] is (b1,b2)=(1,1), the m-th decoder DC sets the selection signal Sel[m] as the H level in the control periods Ts1 to Ts3, when the content shown by the waveform designation signal SI[m] is (b1,b2)=(1,0), the m-th decoder DC sets the selection signal Sel[m] as the H level in the control periods Ts1 and Ts2 and sets the selection signal Sel[m] as the L level in the control period Ts3, when the content shown by the waveform designation signal SI[m] is (b1,b2)=(0,1), the m-th decoder DC sets the selection signal Sel[m] as the H level in the control period Ts1 and sets the selection signal Sel[m] as the L level in the control periods Ts2 and Ts3, and when the content shown by the waveform designation signal SI[m] is (b1,b2)=(0,0), the m-th decoder DC sets the selection signal Sel[m] as the L level in the control periods Ts1 to Ts3.

As shown in FIG. 7, the M transmission gates TG included in the driving signal generation unit 31 are provided so as to correspond to the M discharging units D included in the recording head 30.

The m-th transmission gate TG is turned on when the selection signal Sel[m] output from the m-th decoder DC is in the H level and is turned off when the selection signal is in the L level. The driving waveform signal Com is supplied to one terminal of each transmission gate TG. The other terminal of the m-th transmission gate TG is electrically connected to an m-th output terminal OTN.

When the selection signal Sel[m] is set as the H level and the m-th transmission gate TG is turned on, the driving waveform signal Com is supplied from the m-th output terminal OTN to the discharging unit D[m] as the driving signal Vin[m].

Although will be described later in detail, in the embodiment, a potential of the driving waveform signal Com at a timing when the state of the transmission gate TG is switched from on to off (that is, timing of the start and the end of the control periods Ts1 to Ts3) is set as a reference potential V0. Accordingly, when the transmission gate TG is turned off, the potential of the output terminal OTN is maintained as the reference potential V0 by the volume or the like of the piezoelectric element 300 of the discharging unit D[m]. Hereinafter, for convenience of description, the description will be made by assuming that, when the transmission gate TG is turned off, the potential of the driving signal Vin[m] is maintained as the reference potential V0.

As described above, the control unit 6 controls the driving signal generation unit 31 so that the driving signal Vin is supplied to each discharging unit D in each unit period Tu. Accordingly, each discharging unit D can discharge the amount of ink corresponding to a value shown by the waveform designation signal SI determined based on the formation body data FD in each unit period Tu and can form dots corresponding to the formation body data FD on the formation table 45.

FIG. 9 is a timing chart for illustrating various signals supplied to the driving signal generation unit 31 by the control unit 6 in each unit period Tu.

As shown in FIG. 9, the latch signal LAT includes a pulse waveform Pls-L and the unit period Tu is regulated by the pulse waveform Pls-L. In addition, the change signal CH includes a pulse waveform Pls-C and the unit period Tu is divided into the control periods Ts1 to Ts3 by the pulse waveform Pls-C. Although not shown in the drawing, the control unit 6 synchronizes the waveform designation signal SI with the clock signal CLK in each unit period Tu and supplies the signal to the driving signal generation unit 31 in serial order.

As shown in FIG. 9, driving waveform signal Com includes a waveform PL1 disposed in the control period Ts1, a waveform PL2 disposed in the control period Ts2, and a waveform PL3 disposed in the control period Ts3. Hereinafter, the waveforms PL1 to PL3 may be collectively referred to as the waveform PL.

In the embodiment, the potential of the driving waveform signal Com is set as the reference potential V0 at the timing of the start or the end of each control period Ts.

When the selection signal Sel[m] is in the H level in one control period Ts, the driving signal generation unit 31 supplies the waveform PL disposed in the one control period Ts in the driving waveform signal Com to the discharging unit D[m] as the driving signal Vin[m]. On the other hand, when the selection signal Sel[m] is in the L level in one control period Ts, the driving signal generation unit 31 supplies the driving waveform signal Com which is set as the reference potential V0 to the discharging unit DM as the driving signal Vin[m].

Accordingly, regarding the driving signal Vin[m] supplied by the driving signal generation unit 31 to the discharging unit D[m] in the unit period Tu, when the value shown by the waveform designation signal SI[m] is (b1,b2)=(1,1), the driving signal is a signal including the waveforms PL1 to PL3, when the value shown by the waveform designation signal SI[m] is (b1,b2)=(1,0), the driving signal is a signal including the waveforms PL1 and PL2, when the value shown by the waveform designation signal SI[m] is (b1,b2)=(0,1), the driving signal is a signal including the waveform PL1, and when the value shown by the waveform designation signal SI[m] is (b1,b2)=(0,0), the driving signal is a signal which is set as the reference potential V0.

When the driving signal Vin[m] including one waveform PL is supplied, the discharging unit D[m] discharges a small amount of ink and forms a small dot.

Accordingly, when the value shown by the waveform designation signal SI[m] is (b1,b2)=(0,1) and the driving signal Vin[m] supplied to the discharging unit D[m] includes one waveform PL (PL1) in the unit period Tu, a small amount of ink is discharged from the discharging unit D[m] based on the one waveform PL, and a small dot is formed with the discharged ink.

When the value shown by the waveform designation signal SI[m] is /(b1,b2)=(1,0) and the driving signal Vin[m] supplied to the discharging unit D[m] includes two waveforms PL (PL1 and PL2) in the unit period Tu, a small amount of ink is discharged from the discharging unit D[m] twice based on the two waveforms PL, the small amounts of ink which are discharged twice are combined to each other, and accordingly a medium dot is formed.

When the value shown by the waveform designation signal SI[m] is (b1,b2)=(1,1) and the driving signal Vin[m] supplied to the discharging unit D[m] includes three waveforms PL (PL1 to PL3) in the unit period Tu, a small amount of ink is discharged from the discharging unit D[m] three times based on the three waveforms PL, the small amounts of ink which are discharged three times are combined to each other, and accordingly a large dot is formed.

Meanwhile, when the value shown by the waveform designation signal SI[m] is (b1,b2)=(0,0) and the driving signal Vin[m] supplied to the discharging unit D[m] does not include the waveform PL and is maintained as the reference potential V0 in unit period Tu, the ink is not discharged from the discharging unit D[m] and the dot is not formed (the recording is not performed).

In the embodiment, as clearly described above, the medium dot has a size which is double the size of the small dot and the large dot has a size which is three times of that of the small dot.

In the embodiment, the waveform PL of the driving waveform signal Com is determined so that the small amount of ink discharged for forming a small dot is an amount which is approximately ⅓ of the ink necessary for forming a unit structure. That is, the unit structure is configured with any one of three patterns of one large dot, a combination of one medium dot and one small dot, and a combination of three small dots.

In the embodiment, one unit structure is provided with respect to one voxel Vx. That is, in the embodiment, the dots are formed in one voxel Vx with any one of three patterns of one large dot, a combination of one medium dot and one small dot, and a combination of three small dots.

### 2. Data Generation Process and Formation Process

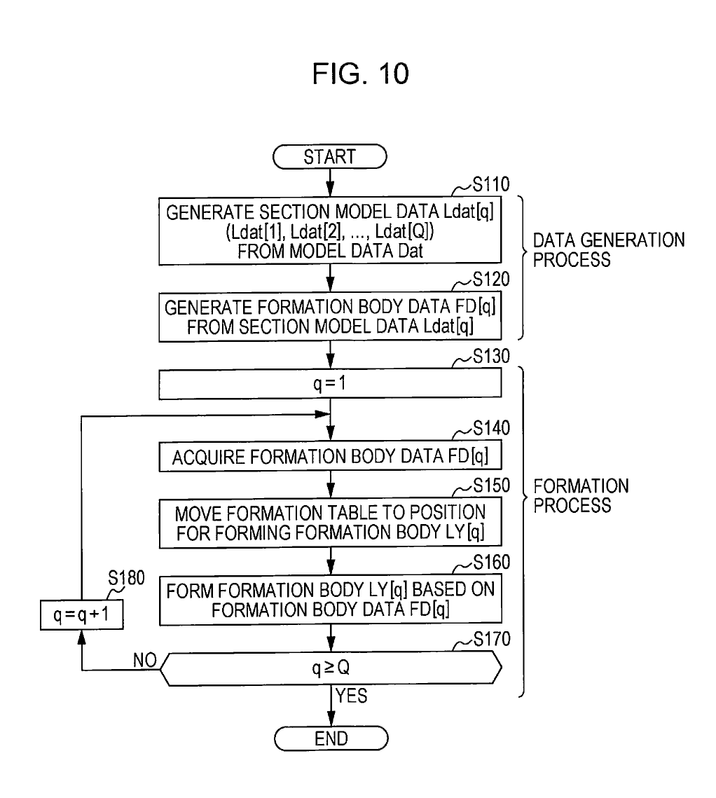

Next, the data generation process and the formation process executed by the three-dimensional object formation system 100 will be described with reference to FIG. 10 to FIG. 13.

### 2.1. Outline of Data Generation Process and Formation Process

FIG. 10 is a flowchart showing an example of the operation of the three-dimensional object formation system 100 when the data generation process and the formation process are executed.

The data generation process is a process executed by the formation data generation unit 93 of the host computer 9 and is started when the model data Dat output by the model data generation unit 92 is acquired by the formation data generation unit 93. The processes in Steps S110 and S120 shown in FIG. 10 correspond to the data generation process.

As shown in FIG. 10, when the data generation process is started, the formation data generation unit 93 generates section model data items Ldat[q] (Ldat[1] to Ldat[Q]) based on the model data Dat output by the model data generation unit 92 (S110).

As described above, in Step S110, the formation data generation unit 93 executes the shape complementation process which is a process of complementing the hollow portion having the shape shown by the model data Dat and generating the section model data Ldat so that a part of or the entire area of the inside of the three-dimensional object Obj is a solid shape.

Then, the formation data generation unit 93 determines the arrangement of the dots to be formed by the three-dimensional object formation apparatus 1 for forming the formation body LY[q] corresponding to the shape and the color shown by the section model data Ldat[q] and outputs the determined result as the formation body data FD[q] (S120).

As described above, the formation data generation unit 93 executes the data generation process shown in Steps S110 and S120 of FIG. 10.

The three-dimensional object formation system 100 executes the formation process after executing the data generation process.

The formation process is a process executed by the three-dimensional object formation apparatus 1 under the control of the control unit 6 and is started when the formation body data FD output by the host computer 9 is acquired by the three-dimensional object formation apparatus 1. The processes in Steps S130 to S180 shown in FIG. 10 correspond to the formation process.

As shown in FIG. 10, the control unit 6 sets “1” for a variable q showing the number of times of execution of the lamination process (S130). Next, the control unit 6 acquires a formation body data FD[q] generated by the formation data generation unit 93 (S140). The control unit 6 controls the lift mechanism driving motor 71 so that the formation table 45 moves to a position for forming the formation body LY[q] (S150).

As the position for forming the formation body LY[q], any position may be used as long as it is a position where the ink discharged from the head unit 3 can be properly landed on a dot formation position (voxel Vxq) designated by the formation body data FD[q]. For example, in Step S150, the control unit 6 may control the position of the formation table 45 so that a space between the formation body LY[q] and the head unit 3 in the Z axis direction is constant. In this case, the control unit 6, for example, may move the formation table 45 in the negative Z direction by an amount of the predetermined thickness ΔZ during the time after the formation body LY[q] is formed in the q-th lamination process and before the formation of the formation body LY[q+1] in the (q+1)-th lamination process is started.

After moving the formation table 45 to a position for forming the formation body LY[q], the control unit 6 controls the operations of the head unit 3, the position change mechanism 7, and the curing unit 61 so that the formation body LY[q] is formed based on the formation body data FD[q] (S160). As clearly described in FIGS. 2A to 2E, the formation body LY[1] is formed on the formation table 45 and the formation body LY[q+1] is formed on the formation body LY[q].

After that, the control unit 6 determines whether or not the variable q satisfies an expression of “q≧Q” (S170). When the determined result is positive, it is determined that the formation of the three-dimensional object Obj is completed and the formation process is finished, and meanwhile, when the determined result is negative, 1 is added to the variable q and the process proceeds to Step S140 (s180).

As described above, the three-dimensional object formation apparatus 1 executes the formation process shown in Steps S130 to S180 of FIG. 10.

That is, by executing the data generation process shown in Steps S110 and S120 of FIG. 10, the three-dimensional object formation system 100 generates the formation body data items FD[1] to FD[Q] based on the model data Dat, and by executing the formation process shown in Steps S130 to S180 of FIG. 10, the three-dimensional object formation system forms the three-dimensional object Obj based on the formation body data items FD[1] to FD[Q].

FIG. 10 is merely an example of the flow of the data generation process and the formation process. For example, in FIG. 10, the formation process is started after completing the data generation process, but the invention is not limited to this embodiment, and the formation process may be started before completing the data generation process. For example, when the formation body data FD[q] is generated in the data generation process, the formation process (that is, the q-th lamination process) of forming the formation body LY[q] may be executed based on the formation body data FD[q], without waiting for the generation of the next formation body data FD[q+1].

### 2.2. Shape Complementation Process

As described above, in Step S120, the formation data generation unit 93 executes the shape complementation process of complementing the hollow portion having shape shown by the model data Dat and generating the section model data Ldat so that a part or the entirety of the inside of the three-dimensional object Obj has a solid structure.

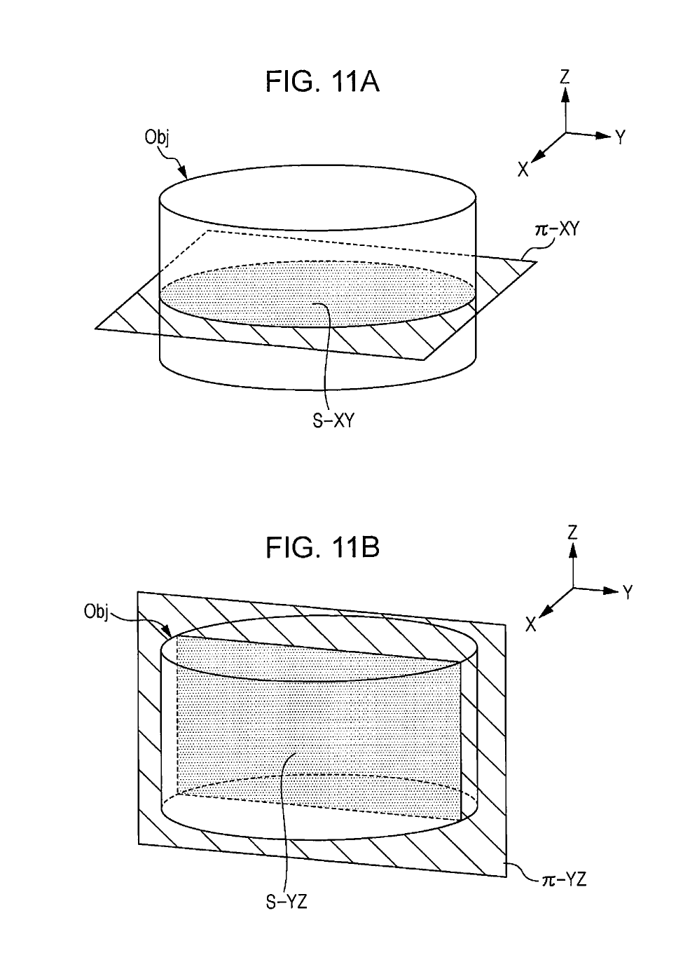

Hereinafter, the inner structure of the three-dimensional object Obj shown by the section model data Ldat and the shape complementation process of determining the inner structure of the three-dimensional object Obj will be described with reference to FIG. 11A to FIG. 13.

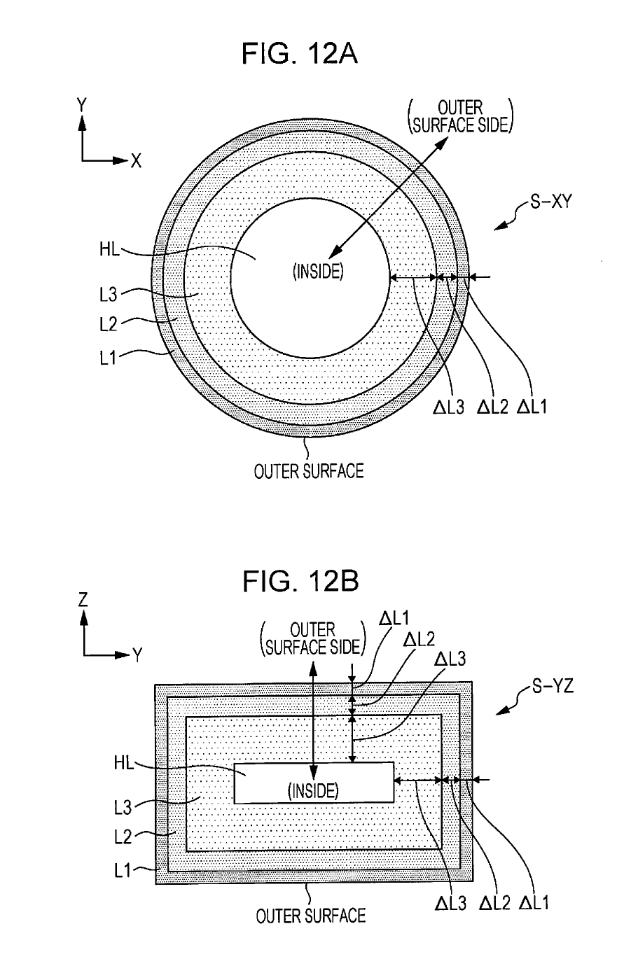

First, the inner structure of the three-dimensional object Obj will be described with reference to FIGS. 11A to FIG. 13. FIG. 11A is a perspective view showing a section S-XY when the three-dimensional object Obj is sectioned along a plane n-XY parallel to an XY plane and FIG. 11B is a perspective view showing a section S-YZ when the three-dimensional object Obj is sectioned along a plane n-YZ parallel to a YZ plane. In FIGS. 11A and 11B, for convenience of drawing, a case of forming a cylindrical three-dimensional object Obj having a shape different from that of FIGS. 2A to 3 is assumed. FIG. 12A is a sectional view showing the section S-XY and FIG. 12B is a sectional view showing the section S-YZ.

As shown in FIGS. 12A and 12B, in the three-dimensional object Obj, three layers of a chromatic layer L1, a white layer L2, and a transparent layer L3 are provided on the inner side of the three-dimensional object Obj with respect to the outer surface (that is, the outline of the three-dimensional object Obj) and a hollow portion HL is further provided on the inner side with respect to the three layers. That is, the three-dimensional object Obj is formed so that the chromatic layer L1, the white layer L2, and the transparent layer L3 are provided between the outer surface of the three-dimensional object Obj and the hollow portion HL.

More specifically, the chromatic layer L1 is provided so as to separate the outer surface of the three-dimensional object Obj and the white layer L2, the white layer L2 is provided so as to separate the chromatic layer L1 and the transparent layer L3, and the transparent layer L3 is provided so as to separate the white layer L2 and the hollow portion HL. Accordingly, the outer surface side of the three-dimensional object Obj with respect to the hollow portion HL is covered with the transparent layer L3, the outer surface side of the three-dimensional object Obj with respect to the transparent layer L3 is covered with the white layer L2, and the outer surface side of the three-dimensional object Obj with respect to the white layer L2 is covered with the chromatic layer L1.

Herein, the chromatic layer L1 is a layer which is formed using the formation ink including at least chromatic ink and is a layer for expressing the color of the three-dimensional object Obj.

The white layer L2 is a layer formed using the white ink and is a layer for preventing the color on the inner portion of the three-dimensional object Obj with respect to the chromatic layer L1 from being visualized from the outside of the three-dimensional object Obj through the chromatic layer L1. That is, the white layer L2 is a layer provided so as to cover the inner side of the chromatic layer L1, in order to properly represent the color of the three-dimensional object Obj as originally intended, with the chromatic layer L1.

The transparent layer L3 is a layer formed using the clear ink and is a layer provided for ensuring strength of the three-dimensional object Obj.

In the embodiment, the three-dimensional object Obj is formed so that a thickness ΔL1 of the chromatic layer L1 and a thickness ΔL2 of the white layer L2 satisfy a relationship of “ΔL1<ΔL2”. Accordingly, it is possible to properly display the color of the three-dimensional object Obj as originally intended and to form the three-dimensional object at the low cost by saving the chromatic ink, compared to a case where the white layer L2 is thinner than the chromatic layer L1.

In the embodiment, the three-dimensional object Obj is formed so that the thickness ΔL1 of the chromatic layer L1 and a thickness ΔL3 of the transparent layer L3 satisfy at least a relationship of “ΔL1<ΔL3”. Accordingly, it is possible to increase the strength of the three-dimensional object Obj, by comparing to a case where the transparent layer L3 is thinner than the chromatic layer L1.

The thickness ΔL3 of the transparent layer L3 is preferably satisfy a relationship of “ΔL2<ΔL3” in a relationship with the thickness ΔL2 of the white layer L2. In this case, it is possible to increase the strength of the three-dimensional object Obj, by comparing to a case where the transparent layer L3 is thinner than the white layer L2.

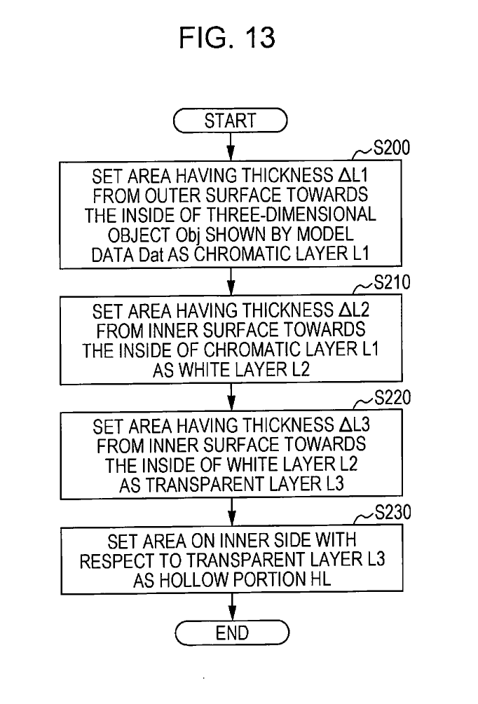

FIG. 13 is a flowchart showing an example of the operation of the formation data generation unit 93 when executing the shape complementation process.

As shown in FIG. 13, the formation data generation unit 93 first determines an area of the model of the three-dimensional object Obj represented by the model data Dat having the thickness ΔL1 from the outer surface of the three-dimensional object Obj to the inside of the three-dimensional object Obj, as the chromatic layer L1 (S200).

The formation data generation unit 93 determines an area having the thickness ΔL2 from the inner surface of the chromatic layer L1 to the inside of the three-dimensional object Obj, as the white layer L2 (S210).

The formation data generation unit 93 determines an area having the thickness ΔL3 from the inner surface of the shielding layer L2 to the inside of the three-dimensional object Obj, as the transparent layer L3 (S220).

The formation data generation unit 93 determines a portion of the inside of the three-dimensional object Obj with respect to the transparent layer L3 as the hollow portion HL (S230).

### 3. Conclusion of Embodiment

As described above, the three-dimensional object formation system 100 according to the embodiment provides the white layer L2 so as to cover the inside of the chromatic layer L1, when forming the three-dimensional object Obj.

As described above, the white ink configuring the white layer L2 reflects visible light at a rate equal to or greater than a predetermined rate over the entire wavelength region. Accordingly, it is possible to prevent the color of the inner portion with respect to the chromatic layer L1 from being visualized through the chromatic layer L1.

In addition, by reflecting visible light passing the chromatic layer L1 in light emitted to the chromatic layer Li from the outside of the three-dimensional object Obj by the white layer L2, it is possible to output the visible light from the outer surface of the three-dimensional object Obj through the chromatic layer L1, again. Accordingly, it is possible to properly and clearly display the color as originally intended in the chromatic layer L1 without strain. Since it is possible to decrease the thickness ΔL1 of the chromatic layer L1 by compared to a case without the white layer L2, it is possible to decrease the manufacturing cost of the three-dimensional object Obj.

The three-dimensional object formation system 100 according to the embodiment provides the transparent layer L3 so as to be thinner than at least the chromatic layer L1. The clear ink forming the transparent layer L3 has the small number of color material components, compared to the chromatic ink or white ink. Accordingly, it is possible to increase the hardness, when the ink is cured.

In general, the cost is low, when using the clear ink having the small number of color material components, by comparing the chromatic ink or the white ink having the larger number of color material components than that of the clear ink. Accordingly, it is possible to increase the strength of the three-dimensional object Obj and to decrease the manufacturing cost of the three-dimensional object Obj, by comparing to a case where the transparent layer L3 is thinner than the chromatic layer L1.

In the embodiment, the chromatic ink is an example of “first liquid”, the white ink is an example of “second liquid”, the clear ink is an example of “third liquid”, the chromatic layer L1 is an example of a “first layer”, the white layer L2 is an example of a “second layer”, and the transparent layer L3 is an example of a “third layer”.

### B. Modification Examples

The above embodiment can be modified in various manners. Specific modified embodiments will be described hereinafter. Two or more embodiments arbitrarily selected from the below examples can be suitably combined with each other in a range not contradicting each other.

In the modification examples below, the same reference numerals used in the above description will be used for the elements exhibiting the same operations or functions as those in the above embodiment and the specific description thereof will be suitably omitted.

### Modification Example 1

In the embodiment described above, the three-dimensional object Obj formed by the three-dimensional object formation system 100 includes the chromatic layer L1, the white layer L2, the transparent layer L3, and the hollow portion HL from the outer surface to the inside of the three-dimensional object Obj, but the invention is not limited to this embodiment, and the three-dimensional object formation system 100 may form the three-dimensional object Obj including at least the chromatic layer L1, the white layer L2, and the transparent layer L3.

For example, the three-dimensional object Obj formed by the three-dimensional object formation system 100 may have a solid structure in which the entire portion of the inner side with respect to the white layer L2 is the transparent layer L3.

The three-dimensional object Obj formed by the three-dimensional object formation system 100 may include a transparent layer (hereinafter, referred to as a “outer surface transparent layer) between the outer surface of the three-dimensional object Obj and the chromatic layer L1 so as to separate the outer surface of the three-dimensional object Obj and the chromatic layer L1. The outer surface transparent layer may be formed with the same material as that of the transparent layer L3, for example. In this case, it is possible to increase the strength of the surface of the three-dimensional object Obj and to decrease a degree of change over time regarding the color displayed by the chromatic layer L1.

The three-dimensional object Obj formed by the three-dimensional object formation system 100 may include a constituent element which is formed with a material different from the chromatic ink configuring the chromatic layer L1 and the white ink configuring the white layer L2, between the chromatic layer L1 and the white layer L2. The three-dimensional object Obj formed by the three-dimensional object formation system 100 may include a constituent element which is formed with a material different from the white ink configuring the white layer L2 and the clear ink configuring the transparent layer L3, between the white layer L2 and the transparent layer L3.

In the three-dimensional object formation system 100, the three-dimensional object Obj may be formed so that the thickness ΔL1 of the chromatic layer L1 and the thickness ΔL2 of the white layer L2 satisfy a relationship of “ΔL1>ΔL2”. Accordingly, the chromatic layer L1 can display dark color. Even in this case, it is preferable to satisfy a relationship of “ΔL1<ΔL3” or “ΔL1<ΔL2” in the relationship with the thickness ΔL3 of the transparent layer L3.

### Modification Example 2

In the embodiment and the modification examples described above, the white layer L2 is used as the second layer and the curable white ink is used as the second liquid forming the second layer, but the invention is not limited to the embodiment, and the second layer may be a layer having a color other than white (WT) and the second liquid may be curable ink other than the white ink.

For example, the second liquid forming the second layer may be curable ink which can reflect visible light at a rate equal to or greater than the predetermined rate. For example, the second liquid may be light cyan ink or light magenta ink. However, the achromatic ink is preferably used as the second liquid, in order to more properly represent the color of the three-dimensional object Obj as originally intended, in the chromatic layer L1.

### Modification Example 3

In the embodiment and the modification examples described above, the three-dimensional object formation apparatus 1 forms the three-dimensional object Obj by laminating the formation bodies LY which are formed by curing the formation ink, but the invention is not limited to the embodiment, and formation bodies LY may be formed by solidifying powder spread in a layered shape by curable formation ink and the three-dimensional object Obj may be formed by laminating the formed formation bodies LY.

In this case, the three-dimensional object formation apparatus 1 may include a powder layer formation unit (not shown) which spreads the powder on the formation table 45 to have the predetermined thickness ΔZ to form a powder layer PW and a powder discarding unit (not shown) which discards the powder (powder other than powder solidified by the formation ink) not configuring the three-dimensional object Obj after forming the three-dimensional object Obj. Hereinafter, the powder layer PW for forming the formation body LY[q] is referred to as the powder layer PW[q].

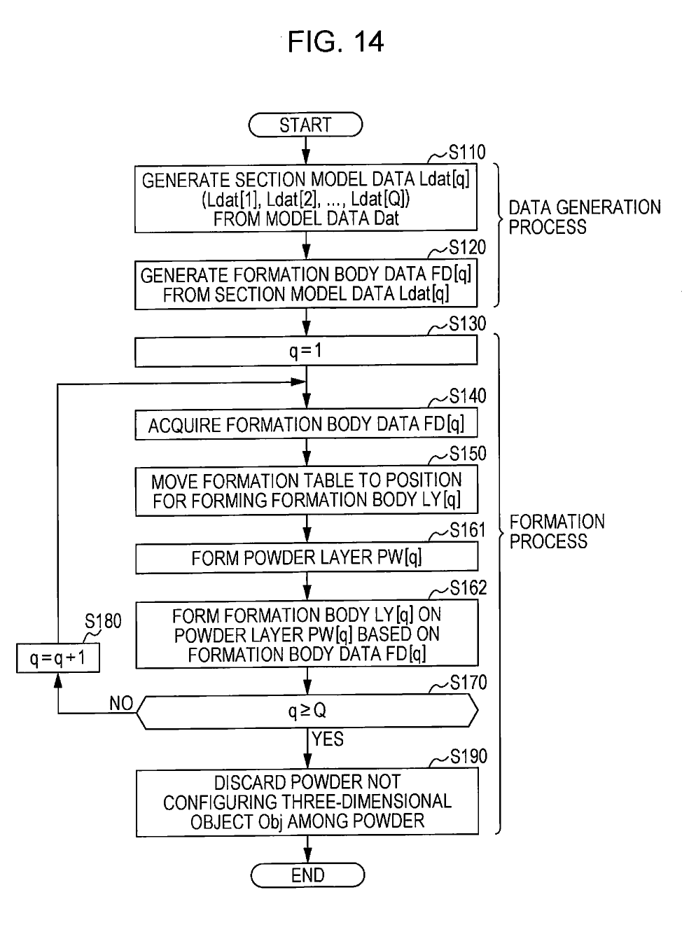

FIG. 14 is a flowchart showing an example of the operation of the three-dimensional object formation system 100 when executing the data generation process and the formation process according to the modification example. The flowchart according to the modification example shown in FIG. 14 is the same as the flowchart according to the embodiment shown in FIG. 10, except for executing the process shown in Steps S161 and S162 instead of Step S160 and executing the process shown in Step S190 when the determined result in Step S170 is positive.

As shown in FIG. 14, the control unit 6 according to the modification example controls the operation of each unit of the three-dimensional object formation apparatus 1 so that the powder layer formation unit forms the powder layer PW [q] (S161).

The control unit 6 according to the modification example controls the operation of each unit of the three-dimensional object formation apparatus 1 so as to form dots on the powder layer PW[q] to form the formation body LY[q] based on the formation body data FD[q] (S162). Specifically, first, in Step S162, the control unit 6 controls the operation of the head unit 3 so that the formation ink or the supporting ink are discharged to the powder layer PW[q] based on the formation body data FD[q]. Next, the control unit 6 controls the operation of the curing unit 61 so as to solidify the powder of a portion where the dots are formed on the powder layer PW[q], by curing the dots formed with the ink discharged to the powder layer PW[q]. Accordingly, the powder of the powder layer PW[q] is solidified with the ink and the formation body LY[q] can be formed.

The control unit 6 according to the modification example controls the operation of the powder discarding unit so as to discard the powder not configuring the three-dimensional object Obj after the three-dimensional object Obj is formed (S190).

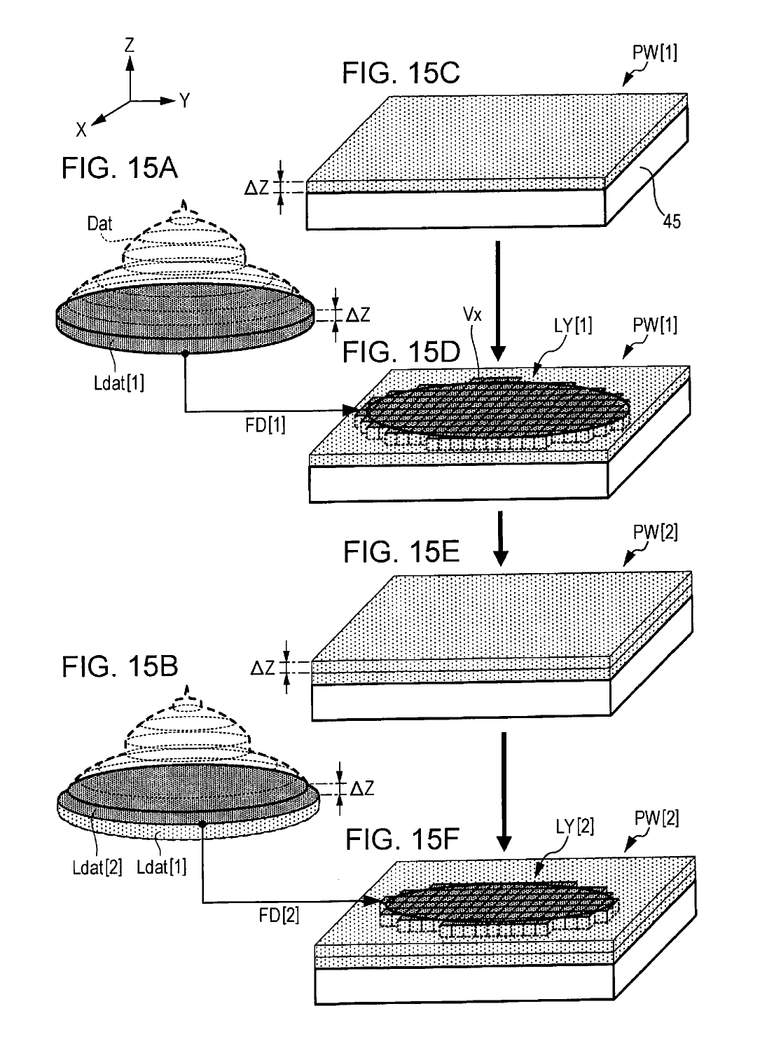

FIGS. 15A to 15F are explanatory diagrams for illustrating a relationship between the model data Dat and the section model data Ldat[q], the formation body data FD[q], the powder layer PW[q], and the formation body LY[q] according to the modification example.

Among these, FIGS. 15A and 15B show the section model data items Ldat[1] and Ldat[2] in the same manner as in FIGS. 2A and 2B. Even in the modification example, the section model data Ldat[q] is generated by slicing the model data Dat, the formation body data FD[q] is generated from the section model data Ldat[q], and the formation body LY[q] is formed with the dots formed based on the formation body data FD[q].

Hereinafter, the formation of the formation body LY[q] according to the modification example will be described with reference to FIGS. 15C to 15F using the formation bodies LY[1] and LY[2] as examples.

As shown in FIG. 15C, the control unit 6 controls the operation of the powder layer formation unit so as to form the powder layer PW[1] having the predetermined thickness ΔZ before forming the formation body LY[1] (see Step S161 described above).

Next, as shown in FIG. 15D, the control unit 6 controls the operation of each unit of the three-dimensional object formation apparatus 1 so that the formation body LY[1] is formed in the powder layer PW[1] (see Step S162 described above). Specifically, first, the control unit 6 controls the operation of the head unit 3 based on the formation body data FD[1] to discharge the ink to the powder layer PW[1] to form the dots. Then, the control unit 6 controls the curing unit 61 so as to cure the dots formed on the powder layer PW[1] to solidify the powder in a portion where the dot is formed and form the formation body LY[1].

After that, as shown in FIG. 15E, the control unit 6 controls the powder layer formation unit so as to form the powder layer PW[2] having the predetermined thickness ΔZ on the powder layer PW[1] and the formation body LY[1]. As shown in FIG. 15F, the control unit 6 controls the operation of each unit of the three-dimensional object formation apparatus 1 so that the formation body LY[2] is formed.

As described above, the control unit 6 forms the formation body LY[q] in the powder layer PW[q] based on the formation body data FD[q] and laminates the formation bodies LY[q] to form the three-dimensional object Obj.

### Modification Example 4

In the embodiment described above, the ink discharged from the discharging unit D is a curable ink such as an ultraviolet curable ink, but the invention is not limited to the embodiment, and ink formed of a thermoplastic resin may be used.

In this case, it is preferable that the ink is discharged in a state of being heated in the discharging unit D. That is, the discharging unit D according to the modification example preferably performs a so-called thermal type discharging process of generating air bubbles in the cavity 320 to increase pressure in the cavity 320 by heating a heating element (not shown) provided in the cavity 320, to discharge the ink.

In this case, since the ink discharged from the discharging unit D is cooled and cured by the outside air, the three-dimensional object formation apparatus 1 may not include the curing unit 61.

### Modification Example 5

In the embodiment and the modification examples described above, the sizes of the dots which can be discharged by the three-dimensional object formation apparatus 1 are three of a small dot, a medium dot, and a large dot, but the invention is not limited to this embodiment, and the types of size of the dots which can be discharged by the three-dimensional object formation apparatus 1 may be one or more.

### Modification Example 6

In the embodiment and the modification examples described above, the formation data generation unit 93 is provided in the host computer 9, but the invention is not limited to this embodiment, and the formation data generation unit 93 may be provided in the three-dimensional object formation apparatus 1. For example, the formation data generation unit 93 may be mounted as a functional block which is realized by operation of the control unit 6 according to the control program.

When the three-dimensional object formation apparatus 1 includes the formation data generation unit 93, the three-dimensional object formation apparatus 1 can generate the formation body data FD based on the model data Dat supplied from the external host computer 9 and form the three-dimensional object Obj based on the generated formation body data FD.

### Modification Example 7

In the embodiment and the modification examples described above, the three-dimensional object formation system 100 includes the model data generation unit 92, but the invention is not limited to this embodiment, and the three-dimensional object formation system 100 may be configured without including the model data generation unit 92.

That is, the three-dimensional object formation system 100 may form the three-dimensional object Obj based on the model data Dat supplied from the outside of the three-dimensional object formation system 100.

### Modification Example 8

In the embodiment and the modification examples described above, the driving waveform signal Com is a signal including the waveforms PL1 to PL3, but the invention is not limited to this embodiment, and the driving waveform signal Com may be any signal, as long as it is a signal including a waveform at which the amounts of ink corresponding to at least one type of the size of the dot can be discharged from the discharging unit D. For example, the driving waveform signal Com may be set as a waveform different depending on the type of the ink.

In addition, in the embodiment and the modification examples described above, the bit number of the waveform designation signal SI[m] is two bits, but the invention is not limited to this embodiment, and the bit number of the waveform designation signal SI[m] may be suitably determined depending on the number of types of the sizes of the dots formed with the ink discharged from the discharging unit D.

What is claimed is:

1. A three-dimensional object formation apparatus comprising:
a head unit which discharges a plurality of types of liquid including first liquid including chromatic color material components, second liquid which reflects visible light at a rate equal to or greater than a predetermined rate, and third liquid having small number of color material components than those of the first liquid and the second liquid, and forms dots with the discharged liquid;
a curing unit which cures the dots; and
a control unit which controls the head unit so that a three-dimensional object is formed with the cured dots,
wherein the control unit controls the head unit so that the three-dimensional object which includes a first layer formed of a plurality of dots including the dots formed with the first liquid, a second layer formed of a plurality of dots formed with the second liquid, and a third layer formed of a plurality of dots formed with the third liquid and in which the first layer and the second layer are provided between the third layer and the outer surface of the three-dimensional object so as to separate the third layer and the outer surface of the three-dimensional object, and the second layer is provided between the first layer and the third layer so as to separate the first layer and the third layer, is formed.

2. The three-dimensional object formation apparatus according to claim 1,
wherein the second liquid includes achromatic color material components.

3. The three-dimensional object formation apparatus according to claim 1,
wherein the third layer is thicker than the second layer.

4. The three-dimensional object formation apparatus according to claim 1,
wherein the third layer is thicker than the first layer.

5. The three-dimensional object formation apparatus according to claim 1,
wherein the second layer is thicker than the first layer.

6. The three-dimensional object formation apparatus according to claim 1,
wherein the first layer is thicker than the second layer.

7. A control method of a three-dimensional object formation apparatus which includes a head unit which discharges a plurality of types of liquid including first liquid including chromatic color material components, second liquid which reflects visible light at a rate equal to or greater than a predetermined rate, and third liquid having smaller number of color material components than those of the first liquid and the second liquid, and forms dots with the discharged liquid, and a curing unit which cures the dots, the method comprising:
controlling the head unit so that the three-dimensional object which includes a first layer formed of a plurality of dots including the dots formed with the first liquid, a second layer formed of a plurality of dots formed with the second liquid, and a third layer formed of a plurality of dots formed with the third liquid and in which the first layer and the second layer are provided between the third layer and the outer surface of the three-dimensional object so as to separate the third layer and the outer surface of the three-dimensional object, and the second layer is provided between the first layer and the third layer so as to separate the first layer and the third layer, is formed with the cured dots.

8. A control program of a three-dimensional object formation apparatus which includes a head unit which discharges a plurality of types of liquid including first liquid including chromatic color material components, second liquid which reflects visible light at a rate equal to or greater than a predetermined rate, and third liquid having a smaller number of color material components than those of the first liquid and the second liquid, and forms dots with the discharged liquid, a curing unit which cures the dots, and a computer, the program causing the computer to function as:
a control unit which controls the head unit so that the three-dimensional object which includes a first layer formed of a plurality of dots including the dots formed with the first liquid, a second layer formed of a plurality of dots formed with the second liquid, and a third layer formed of a plurality of dots formed with the third liquid and in which the first layer and the second layer are provided between the third layer and the outer surface of the three-dimensional object so as to separate the third layer and the outer surface of the three-dimensional object, and the second layer is provided between the first layer and the third layer so as to separate the first layer and the third layer, is formed with the cured dots.
